(19) United States
(12) Patent Application Publication
(10) Pub. No.: US 2005/0267778 A1
(43) Pub. Date: Dec. 1, 2005

(54) Virtual consultation system and method

(76) Inventor: William Kazman, Westford, MA (US)

Correspondence Address: MCDERMOTT WILL & EMERY LLP;ATTN: INTELLECTUAL PROPERTY DEPTARTMENT DOCKETING, 28 STATE STREET, BOSTON, MA, 02109, US

(21) Appl. No.: 11/138,922

(22) Filed: May 26, 2005

Related U.S. Application Data
(60) Provisional application No. 60/575,128, filed on May 28, 2004.

(51) Int. Cl. G06F 17/60

(52) U.S. Cl. 705/1

(57) ABSTRACT

A virtual consultation system and method enables a user to receive interactive real, or near real, time consultation from at least one consultant, wherein the consultant and consultation information are presented to the user via a plurality of presentation means.

### CROSS REFERENCES TO RELATED APPLICATIONS

This application claims the benefit of priority under 35 U.S.C. §119(e) from co-pending, commonly owned U.S. provisional patent application Ser. No. 60/757,128, entitled VIRTUAL SALES PORTAL, filed May 28, 2004.

### FIELD OF INTEREST

The present inventive concepts relate to the field computer-aided systems and methods for providing interactive consultation across one or more networks.

### BACKGROUND

Over the years the manner and mediums through which sales information and transaction conduct have become increasingly computer-based, though still leave much to be desired. For example, the several content-driven, media-based selling models have been variously successful over the years.

The first is Print Media (e.g., catalogues, newspapers, magazines), characterized by 1) one-way info exchange and 2) personal relationship facade. The user only receives information and the communication is impersonal, or not user specific. The next is Television (e.g., QVC), also characterized by 1) one-way information exchange and 2) personal relationship facade. Here, transaction conduct required a separate communication for example or a phone-based sales consultant ready to process the transaction. The next is the Internet (e.g., Amazon.com), characterized by 1) two-way information exchange and 2) anonymous relationship. In other words, the user can receive information as requested, for the most part, dependent on what is available on-line and can conduct a transaction. However, such sessions are not truly interactive, since the user is merely navigating itself around pre-supplied databases.

None of these systems, however, provide a user (e.g., shopper) with a true high quality two-way interactive on-line consultation that is real-time—similar to that which a user could experience had it been face-to-face with the consultant. To date, that kind of experience has largely required collocation of the user, consultant and information necessary to provide the consultative session or perform a transaction. This can be highly inefficient for the user.

### SUMMARY OF INVENTION

The present inventive concepts relate to a method of providing consultation over a computer network comprising the steps of providing a consultation system comprising at least one consultant device, configured for communicating with a user device via a network, the method further comprises establishing a consultation session between the at least one consultant device and the user device and presenting real-time communications between the consultant device and a first presentation means of the user device and presenting consultation information via a second presentation means of the user device, as a function of information from the consultant system.

In accordance with another aspect of the present invention, provided is a consultation kiosk comprising a network interface configured for linking to a consultation system that includes at least one consultation device. The kiosk also comprises at least one processor coupled to the network interface and to at least one input device for receiving information relating to a user of the kiosk, a first presentation means configured for presenting real-time conferencing communications with the consultant device, and a second presentation configured for presenting consultation information via a second presentation means as a function of information from the consultant system.

In accordance with another aspect of the present invention, provided is a computer program product residing on a computer readable medium having a plurality of instructions stored thereon for execution by at least one processor of a consultation system. The consultation system comprises a link to at least one consultant device configured for communicating with a user device to perform a method of consulting comprising the steps of establishing a consultation session between the at least one consultant device and the user device, the method also establishing real-time conferencing communications via a first presentation means of the user device, and generating consultation information for presenting via a second presentation means of the user device as a function of information from the consultant system.

In accordance with another aspect of the present invention, provided is a consultation system for enabling consultation over a computer network, the consultation system comprising at least one consultant device configured for communicating with a user device via a network, means for establishing a consultation session between the at least one consultant device and the user device, means for presenting real-time conferencing communications between the consultant device and a first presentation means of the user device and means for presenting consultation information via a second presentation means of the user device as a function of information from the consultant system.

### BRIEF DESCRIPTION OF THE DRAWINGS

The drawing figures depict preferred embodiments by way of example, not by way of limitations. In the figures, like reference numerals refer to the same or similar elements.

FIG. 1 is a flow diagram of a method of providing virtual consulting.

FIG. 2 is a system block diagram capable of implementing the method of FIG. 1.

FIG. 3 is a block diagram of a kiosk that may comprise a portion of the system of FIG. 2.

FIG. 4 is a block diagram of a set of computer program products that may embody various portions of the instructions executed by portions of the system of FIG. 2.

### DETAILED DESCRIPTION OF PREFERRED EMBODIMENT

Provided herein is a description of various aspects and embodiments of a system and method for providing consultation over a computer network, which may be referred to as consultation sessions. As used herein, a consultation (or consultation session) is an on-line, real (or near real)—time interaction among parties to, for example, obtain information, advice, guidance, assistance, or opinions, or to conduct a transaction, or some combination thereof, within the context of a certain subject matter. Generally, at least one user operating from at least one location can participate in an interactive consultation session over at least one network. The interaction is with at least one consultant, and may be accomplished using any of a variety of commonly available and properly configured networkable devices. A consultant, as used herein, is an entity knowledgeable in the subject matter of the consultation session and having access to relevant information, data, resources and functions for informing, advising, assisting, or providing opinions to the user or facilitating, enabling, or conducting a transaction for or with the user, or some combination thereof. As will be appreciated by those skilled in the art, such a system and method may be useful in any of a wide variety of contexts.

As discussed above, a consultation session may be a means for conducting or facilitating a transaction within the context of the subject matter by, for, or on behalf of the at least one consumer, as a user. The term transaction is used broadly to have any ordinary meaning, including, but not limited to, procurement of goods or services and related activities in conjunction with a consultation session. The term transaction may additionally, or alternatively, include obtaining guidance, maintenance information, instructional information, or training, and the like. Thus, a consultant could be a salesperson, counselor or advisor, technician or serviceman, instructor, trainer, or teacher—as just a few examples.

In any consultation session, the communication, in addition to being interactive communication between the consultant(s) and user(s), may also include the consultant(s) providing a set of information related to the subject matter, which may be referred to as consultation information. Thus, as examples, consultation information could include sales, product or service, promotional, financial, technical, training, maintenance, educational, statistical, analytical, comparative or other such information—it will generally be a function of the subject matter and information available. It could additionally, or alternatively, be a function of other factors as well, such as information about, related to, or provided by the user(s), consultant(s), or both.

Depending on the embodiment, information related to the interaction with the consultant could be presented via a first presentation means and the consultation information could be provided via at least one other presentation means, e.g., separate window or screen. In other embodiments, a single presentation means could be used, with the consultant and consultation information selectively and alternatively being presented via the single presentation means.

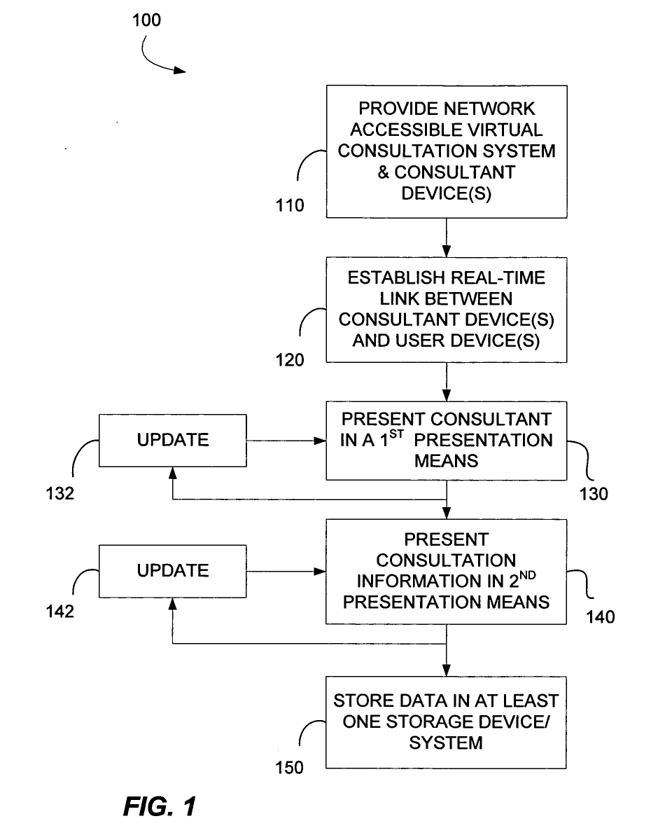

As an example, such a system and method could be implemented as a virtual sales system, wherein a consumer-user engages in an interactive dialog with at least one remote sales consultant (or agent or representative) regarding various product or service offerings. In other embodiments, as discussed above, the virtual consultation system could be implemented as an educational system, training system, maintenance or repair system, medical system, testing system, counseling system or navigation system—as just a few examples. FIGS. 1 through 4 provide one representative embodiment, or implementation as a virtual sales consultation system and method—for illustrative purposes. Those skilled in the art will appreciate that the virtual consultation system and method have no inherent limitations with respect to subject matter or transaction type.

FIG. 1 is a flowchart 100 depicting a method of providing virtual consulting. The method presumes the existence of at least one user device or station having access to a network and having typical user input devices known in the art, such as a mouse, keyboard, microphone, joystick or touch screen. The user device also includes at least one presentation means, such as one or more video displays and audio outputs. In step 110, provided is a virtual consultation system that is accessible via one or more networks. One or more network enabled consultation systems or devices is also provided, which may be collocated with the virtual consultation system or remote to it.

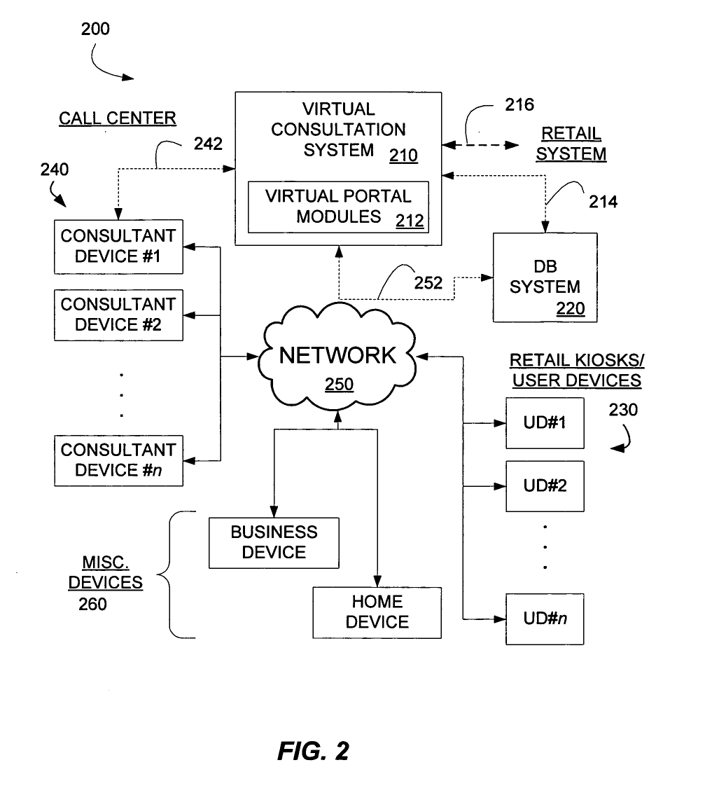

In step 120, a link is established between the user device and at least one consultation device, via the virtual consultation system and over one or more networks. Such networks (shown as network 250 in FIG. 2) may include any wired or wireless networks, or combination thereof, and may comprise one or more of the Internet, a local area network (LAN), wide area network (WAN), telephony network, satellite network, cable network, or virtual private network (VPN), whether alone or in combination.

In various embodiments, the link (e.g., connection enabling communication) may be established in response to an input by the user at the user device, such as user manipulation of an input device of the user device, or by the user device sensing or detecting the presence of a user. For example, such sensing could be accomplished by a motion detector, audio detector, visual detector or some combination thereof. In any such environments, the user device may accept bio-information as a means of detecting or determining an identity of a user. In other forms, the user may log in at a user device or otherwise identify itself via inputs at a user device.

With the link established, a consultant may be presented through a first presentation means at the user device, in step 130. As needed, in step 132, the presentation of the consultant in that first presentation means is updated, for example, to maintain the real-time consultation. The presentation via the first presentation means may be live (i.e., real or near-real time) audio, video or both of the consultant. In other embodiments, the consultant may be an interactive virtual computer generated consultant, for example, preprogrammed to respond to anticipated user inputs and queries based on the subject matter of the consultation session, and may be a pre-programmed for conducting a transaction. In other embodiments the consultant may be represented as an avatar, lip synchronized to the speech of the consultant. In various embodiments, more than one consultant may be presented at the user device.

As is shown in step 140, information related to the transaction (e.g., consultation information) may be presented via a second presentation means at the user device, e.g., an audio visual display screen or window. In various embodiments, the consultant can control the presentation of the consultation information, which may be taken from any of a variety of sources. For example, in a retail context, the consultant, either directly or through the virtual consultation system, may have access to information related to the various products and services being offered. Depending on the embodiment, the user can interact with this information through user input at the user device. For example, if the consultant presented a selection of products in the second presentation means, the user may be able to select a product or products for obtaining further information. The user may also be able to add a product or products a “shopping cart.” The user may be allowed to select from links, menus or icons also presented via the second presentation means, input customer information, fill-out surveys or questionnaires and the like.

The second presentation means may be or comprise a standalone display or screen or a second window on a shared display or screen. In various embodiments, a single display or screen may be provided that serves as both the first and second presentation means by alternating between the presentation of the consultant and the presentation of the consultation information. Regardless of the form, in step 142, the consultation information is updated as needed.

Preferably, in step 150, consultation information from the consultation session is stored for future reference—for example, if the consultation session was not completed. For example, a consultation session may not be completed if the consultation session is terminated prior to a user completing a transaction, such as a purchase of products or services, finishing data entry, completing an educational, training or instructional setting—depending on the subject matter of the consultation session. The consultation information of completed consultations may also be stored for historical or accounting purposes, and to help identify potential future wants or needs of the user. In a retail implementation, stored information may include consultation information, including, but not limited to, date and time of the session, user identity or other user information, information about products or services queried, or identification and price quotes of products or services reserved or put in a shopping cart, but not yet purchased, or proposals for products or services. The consultation information may be stored in a storage device or system to which the virtual consultation system has access.

FIG. 2 shows a block diagram 200 of a series of devices and components that may comprise a virtual consultation system and may be used in performing a virtual consultation session. A virtual consultation system 210 may provide the primary resources and management for conduct of the virtual consultation sessions. The virtual consultation system 210, therefore, may include a set of virtual portal modules 212 that include a series of components or computer program products that have executable instructions necessary for implementing the method of FIG. 1, as an example. The virtual consultation system 210 may access one or more database or data storage systems 220 via a local network (indicated by dashed line 214) or remote network 250 (indicated by dashed line 252), or some combination thereof. In a retail context, the virtual consultation system 210 may access one or more retail systems via the same or different networks (indicated by dashed line 216) having, for example, product and service information and databases. Such retail systems may also have sales transaction and account management functionality, although those could also be provided by third party systems.

Users may access the virtual consultation system 210 via network 250 using any of a variety of types of systems, stations or devices, collectively referred to as user devices 230 and miscellaneous devices 260. User devices (UD) are shown as UD#1, UD#2 . . . UD#n. Network 250 may any of a variety of types of networks, as previously described. As an example, in the retail context “kiosks” 230 may be included in retail stores or outlets, or other public locations, as a user device that can access the virtual consultation system 210 via one or more networks 250. Generally speaking, a kiosk can be a computer-based device or system that supports the functions described herein and is generally stationed at a location for open access by the general public or a predetermined population, e.g., consumers in a store. The miscellaneous devices 260 that could also be used to access the virtual consultation system 210 can be any of a variety of devices capable of accessing network 250 and which are not stationed for open access by the general public or a predetermined population. As is shown in FIG. 2, such devices may include business devices or home (i.e., personal) devices. Such devices may include, but are not limited to, personal computers, laptops, personal digital assistants (PDAs), cell phones or other such devices capable of accessing network 250.

A set of consultant devices 240 is provided and may be configured in or as part of a “call center.” The consultant devices 240 may or may not be geographically collocated with each other or with the virtual consultation system 210. If local to the virtual consultation system 210, the consultant devices 240 may access the virtual consultation system via a LAN, indicated by dashed line 242. If remote, the consultation devices 240 may access the virtual consultation system 210 via network 250. In this embodiment, the consultant device may by any Internet capable computer (or device), preferably having audio and videoconferencing capability. In a retail context, a consultant may be a person with knowledge of the products and services being offered and access to product information from the retail system, data storage system 220, or both, or from other third party sources.

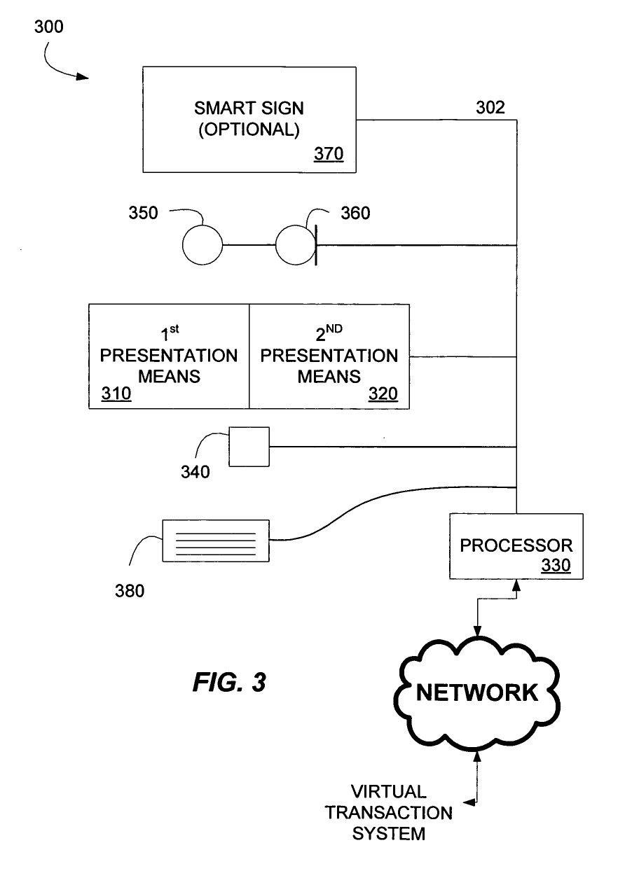

FIG. 3 is a block diagram of one embodiment of a kiosk that could be used with the virtual consultation system 210, such as kiosk/user devices 230 of FIG. 2. Preferably, Kiosk 300 includes video and audio conference capability, comprising a first presentation means 310 and a second presentation means 320, such as one or more video displays which preferably also includes audio output. As discussed above, presentation means 310 and 320 may be comprised of two or more displays, two or more windows within the same display or two or more portions of the same window, as examples. Otherwise, presentation means 310 and 320 could be presented within the same display or window, as examples, and alternate in that display or window.

As also discussed above, first presentation means 310 may be a means by which the consultant conferences with the user. The conferencing of the consultant via the first presentation means 310 gives the user a face-to-face interaction, which results in a personal and productive experience for the user. The second presentation means 320 may be a means by which consultation information is presented to the user, such as price, availability, promotion, specifications information related to products and services being offered. The presentation of consultation information via the second presentation means 320 may be under the control of the consultant, the user, or both. But in the preferred embodiment, the consultation information is provided as a function of the consultant's input, at least in part. This allows the consultant to guide and conduct the consultation session in a meaningful, informative and efficient manner—providing the user with needed or desired information, such as might be needed to investigate, view, compare or purchase products in a retail context. For example, in a retail context, the kiosk could be placed within a store as a way of allowing customers within the store to gain information and guidance with respect to the products and services being offered by that store, and to conduct transactions for such products and services.

At least one detector 340, such as a motion detector, video detector or audio detector, may be included to detect the presence of a user. In such a case, detection of a user may trigger the initiation of a consultation session. At least one camera 350 may be provided such that the user may be viewed by the consultant and at least one audio input 360 (e.g., microphone or telephone) may be provided as another input for the user to facilitate interaction with the consultant. Such video and audio inputs allow a natural interactive, face-to-face conferencing between the consultant and the user. A set of user input devices 380 may also be provided to allow direct user inputs. The set of user input devices may include one or more of a keyboard, mouse or touch-screen, as examples.

At least one processor 330 is provided for executing instructions and processing information related to the consultation session, and particularly with regard to providing content to the first and second presentation means 310, 320, accepting and processing inputs from the user input devices 380, sensor 340, camera 350 and audio input 360 and for communicating via network 250 with the virtual consultation system 210. Processor 330 may be a processor of the type typically used in a workstation, personal computer, laptop, or server or similar device, as examples, but other processors known or later developed could also be used so long as such processors are capable of supporting the above functions.

A smart screen or sign 370 may also be provided as a means for providing any of a variety of types of information, such as promotional information. The promotional information presented via smart sign 370 may be provided as a function of the consultation information of the current consultation session, or of a prior consultation session for the same user. The various elements in FIG. 3 may be interconnected in any of a variety of ways known in the art, such as cabled together or interconnected via a local data bus 302. In one embodiment, the kiosk comprises a typical desktop computer with at least two displays, a keyboard, camera, microphone and interface to network 250, e.g., either directly via a modem or through a LAN.

Additionally, a user login or other security means (not shown) may be included with the kiosk. The user may have an account managed at the virtual consultation system that is maintained with data from past consultation sessions and transactions, and with information that supports the security at the kiosk. Login at the kiosk could make that historical data and general user account data available during the current consultation session. To facilitate purchase transactions, the kiosk may also include at least on credit card swiper and receipt printer. Of course, credit card information could be entered view the keyboard (or other data entry means) and the receipt could be printed by a typical laser, ink jet or other printer.

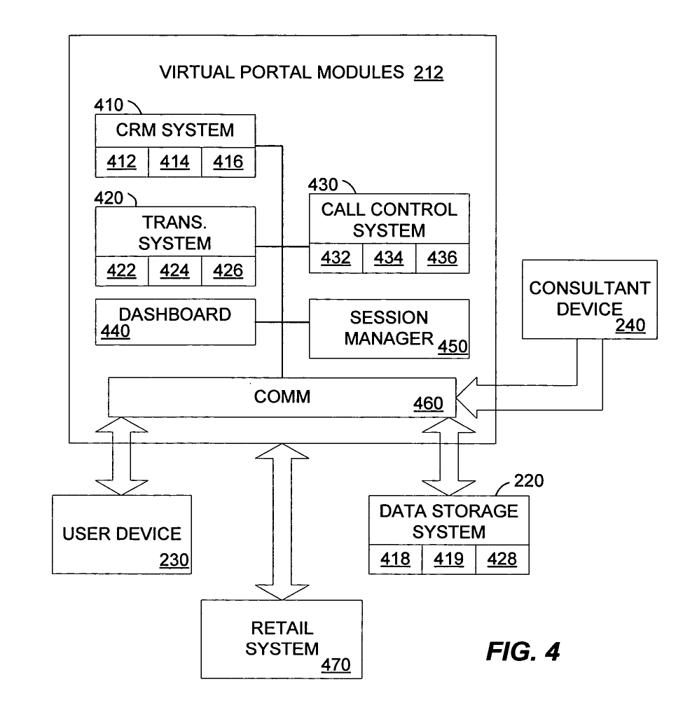

FIG. 4 provides a block diagram of the various computer program products that may be used in virtual consultation system 210, as a set of virtual portal modules 212 (also shown in FIG. 2). In this embodiment, the virtual portal modules 212 are implemented in a retail context as a set of virtual sales portal modules. Generally, these modules comprise a database driven application that is hosted on a centralized server at the virtual consultation system 210, sitting on an Internet backbone (e.g., network 250). The virtual portal modules 212 present to users (e.g., customers and prospects) as an Internet portal to their own personal, human sales consultant and presents to the consultants as a browser-based dashboard for establishing and maintaining personal, face-to-face relationships with the users. In this embodiment, the consultant is a virtual sales consultant having sales skills and knowledge and, preferably, with the ability to manage an account/contact portfolio of customers and prospects with the aid of the virtual consultant system 210.

For example, the virtual portal modules 212 may include a customer relations management (CRM) system (or subsystem) 410. In this embodiment, the CRM module 410 comprises a prospecting engine 412, account management engine 414, campaign management system 416, communications objects database 418 and a sales database 419. In other embodiments, and contexts, the modules may be different—implementing functions specific to the context of each other embodiment.

The prospecting engine 412 includes a set of instructions that are capable of guiding a consultant through a series of business process steps to a take a prospect from first contact to closed transaction. A prospect is a user that has been identified as having, or potentially having, an interest in a product or service. A prospect may or may not have made a prior transaction with or via the virtual consultation system. The account management engine 414 includes a set of instructions that are capable of guiding a consultant through a series of business process steps to take a customer from execution of a purchase transaction to completion of product delivery or service implementation.

The campaign management system 416 maintains outbound communication (drawing from the communications objects DB 418) with customer—users and prospect—users via an automated series of one or more of e-mails, phone calls, mass mailings, or the like, as examples, according to a set of rules that characterize customer revenue potential and optimum “touch” patterns to maximize that revenue. The virtual consultation system 210 may include artificial intelligence configured to tailor the set of rules as a function of historical data with the user, or with users generally, by applying known statistical predictive modeling techniques or pattern recognition techniques. The set of rules may be initially generated as a means of executing a desired marketing strategy.

The communications objects DB 418 may be included in data storage system 220, for example, and contain an archive of standardized communications templates and mass instantiations of such templates, including e-newsletters, special e-mail offers, new customer welcome letters, courtesy call scripts, and the like.

The sales DB 419 is a flexible database that may contain customer and prospect information and profiles, and may be included in data storage system 220. The sales database 419 may also include user-related communications events, purchase transactions, service events, prospecting status, business processes and other information linked together and accessible via a reporting module (not shown). This information and data may comprise or be derived from transaction data generated during consultation sessions with the user (e.g., customer or prospect).

A transaction system 420 may also be included and may comprise an on-line shopping cart system, 422, e-procurement system 424, a product/service database 426 and an accounting system 428. The transaction system 420 facilitates completion of a transaction. The shopping cart system 422 provides for transaction execution, including bill of sale creation, credit card processing, invoice generation, account statement generation, reporting, and secure access for users and consultants. The related information is stored in the accounting system 428, which may comprise part of the virtual consultation system 210 or part of a separate retail system, or other system. The e-procurement system 424 provides general management of a transaction, coordinating and facilitating the shopping cart system 422, product/service DB 426, and accounting system 428 to ensure that the transaction is properly executed. The product/service DB 426 may be stored as part of a different database inventory system of the retailer, or it could be part of data storage system 220. The product/service DB 426 is a multimedia archive containing electronic product and service presentation collateral used by the consultants to interactively present proposals to the prospect-users over network 250, and to create proposals for e-mail or facsimile transmissions, as examples. The product/service DB 426 may also include a question and answer (Q&A) knowledge base, providing consultants with rapid, electronic access to commonly asked questions.

In this embodiment, the call control system 430 includes a communications manager 432 and associated communications drivers 434, and a custom ID detector 436. The communications manager 432 routes and queues inbound video, audio, e-mails and instant messaging to consultants and provides utilities for managing network traffic in the retail kiosk performance. Within the communications manager 432 and its associated communications drivers 434 is the ability for real-time, face-to-face, video conferencing over the network 250. Additionally, animated avatars, personalized in the anthropomorphic form of each consultant and with lip synchronization to a real-time audio stream produced from the speech of the consultant can be used in place of the real-time video conferencing for narrower bandwidth communications.

Also preferably provided in this embodiment is the customer ID detector 436, which is a module that attempts to proactively identify prospects via face recognition at the retail kiosks or using data from a browser cookie to detect web surfers. Otherwise the user could be detected via a secure account-based login protocol. Database records from an identified prospect-user are presented to its on-duty assigned consultant(s) so that the consultant(s) may proactively greet and assist the prospect-user. Web surfers or retail kiosk browsers that cannot be identified are designated as anonymous, live prospects and signaled as such to on-duty consultants for proactive greeting and assistance offering.

A dashboard module 440 is a browser-based module that provides, in this embodiment, status and control of the underlying virtual portal modules 212 and databases to the virtual consulting system 210. From the dashboard 440, the virtual consultant can initiate and receive video calls over network 250 (e.g., the Internet) to the retail kiosks or multi-media PC workstations, as examples, in retail locations and each user's (e.g., customer's and prospect's) businesses and homes. Additional controls support launching of collaborative presentation tools for reviewing a product specification with the remote user, and for filling out purchase consultation information. A unified messaging console on the dashboard allows for prioritized response generation to voicemails, e-mails, e-faxes, audio calls on hold, and video calls on hold. Notifications are displayed of automatic user communications events, new product introductions and other events requiring a consultant's acknowledgment. A task queue for outbound calls, sales business process steps, and account management business process steps may also be provided. Summary sales performance statistics may be provided, along with an entry point to a more detailed reporting module.

Session manager 450 may be included to provide general session support and administration. A communications manager 460 may also be provided as a general communications interface to external systems, including network 250. Consultant device 240 may be a workstation at a remote location operated by one or more consultants via the corn manager 460, as discussed previously (particularly with respect to FIG. 2). The virtual consultation system 210 may access data storage system 220 for reading and writing a wide variety of information and data, as previously discussed. The virtual consultation system 210 may interface with a retail system 470 that provides product and promotional information, as examples, for a retail operation that is providing the context for the virtual consultation system. As mentioned earlier, user device 230 can be any known networkable electronic device.

In this embodiment the virtual consultation system 210, including virtual portal modules 212, embodies elements of a complete consultative selling process:

1) face-to-face, long term, personal relationship development and management:
a. face-to-face interactions are achieved via real-time, interactive videoconferencing, and use of animated avatars, preferably personalized in the anthropomorphic form of the consultant, and with lip synchronization to a real-time audio stream produced from the speech of the consultant (or from computer generated or prerecorded speech), and
b. trust is built over time via a system of personal communications that are customized for each customer/user—consultant relationship and are created and delivered automatically by the virtual portal modules 212 and communications infrastructure;

2) delivery of personalized service and information to support the relationship over time:
a. a detailed DB accumulates information related to the user for access by the consultant, for all of the transactions, purchases, communications and support history of the user, and
b. every type of user—consultant interaction is modeled in a business process workflow, and implemented in software to prompt and guide the consultant in an optimal approach to interacting with the user, while ensuring consistent quality and responsiveness over the life of the relationship; and

3) communication rich, information content about products and services:
a. a cross-indexed, multimedia DB contains detailed information about products and services,
b. a Web-front end to the DB provides browser-based presentation and navigation of the product and service data on the user device (e.g., kiosk or personal computer),
c. collaborative technology allows the consultant to remotely control the display and navigation of the product and service data on the user device, and
d. the combination of collaborative product and service information presentation with the face-to-face interaction via videoconferencing or animated avatar creates a consultative selling interaction between a user and a remote consultant that performs effectively like an in-person sales rep—customer interaction (in a retail context).

While the above embodiment has been described in the context of a retail sales implementation for a single retail chain, it need not be so limited. For example, a consultant could have access to a wide variety of sources of products and services and may provide guidance with respect to preferred sources, as well as with respect to products and services of interest. The consultant could provide guidance as an on-line auctioneer, travel agent, teacher, product maintainer, medical professional or any other service provider.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. As used herein, the terms “includes” and “including” mean without limitation. It is intended by the following claims to claim any and all modifications and variations that fall within the true scope of the inventive concepts.

1. A method of providing consultation over a computer network comprising the steps of:
A. providing a consultation system comprising at least one consultant device, configured for communicating with a user device via a network;
B. establishing a consultation session between the at least one consultant device and the user device, comprising:
a) presenting real-time conferencing communications between the consultant device and a first presentation means of the user device; and
b) presenting consultation information via a second presentation means of the user device as a function of information from the consultant system.

2. The method of claim 1 wherein the consultation information includes information relating to at least one of a product or a service offering.

3. The method of claim 1 wherein the consultation information includes information relating to at least one of training, education, or instruction.

4. The method of claim 1 wherein step B includes establishing the consultation session in response to a trigger event including at least one of receiving detection of a user at the user device or receiving a message indicating an input of the user at the user device.

5. The method of claim 1 wherein the user device is a device from a group comprising a kiosk, a personal or laptop computer, a telephone, or a personal digital assistant.

6. The method of claim 1 further comprising retrieving from a database information relating to at least one prior consultation session involving the user.

7. The method of claim 6 wherein the consultation session is a reestablishment of the prior consultation session.

8. The method of claim 1 further comprising storing session information in a data storage system in conjunction with an identification of the user interacting with the user device.

9. The method of claim 1 further comprising storing session information in a data storage system in conjunction with an identification of the user interacting with the user device.

10. The method of claim 1 wherein the presenting of real-time communications includes presenting audiovisual information representing a consultant in the first presentation means.

11. The method of claim 10 wherein the consultant is a virtual consultant and presenting audiovisual information includes providing an anthropomorphic representation of the virtual consultant synchronized to an audio stream of speech of the virtual consultant.

12. The method of claim 1 further comprising receiving at the at least one consultation device audio and video information of a user at the user device.

13. The method of claim 1 wherein in step B. b) includes presenting the consultation information via the second presentation means of the user device as a further function of information from the user device.

14. A consultation kiosk comprising:
A. a network interface configured for linking to a consultation system comprising at least one consultation device;
B. at least one processor coupled to the network interface and to at least one input device for receiving information relating to a user of the kiosk;
C. a first presentation means configured for presenting real-time conferencing communications with the consultant device; and
D. a second presentation configured for presenting consultation information via a second presentation means as a function of information from the consultant system.

15. The kiosk of claim 14 wherein the consultation information includes graphical and textual information related to products, services, instruction, training or education.

16. The kiosk of claim 14 wherein the real-time information includes audiovisual information depicting a consultant.

17. The kiosk of claim 16 wherein the consultant is a virtual consultant and the second presentation means is configured for providing an anthropomorphic representation of the virtual consultant synchronized to an audio stream of speech of the virtual consultant.

18. The kiosk of claim 14 wherein at least one of the first presentation means or second means is a display screen.

19. The kiosk of claim 14 comprising at least one device from a group comprising a personal or laptop computer, a telephone, or a personal digital assistant.

20. The kiosk of claim 14 further comprising at least one detector for detecting a user at the kiosk.

21. The kiosk of claim 20 wherein the at least one processor is configured to establish a consultation session with the at least one consultant device in response to the detector detecting a user.

22. The kiosk of claim 14 wherein the second presentation means is configured for presenting the consultation information as a further function of information from the at least one device.

23. A computer program product residing on a computer readable medium having a plurality of instructions stored thereon for execution by at least one processor of a consultation system comprising a link to at least one consultant device configured for communicating with a user device to perform a method of consulting comprising the steps of:
A. establishing a consultation session between the at least one consultant device and the user device, comprising:
a) establishing real-time conferencing communications via a first presentation means of the user device; and
b) generating consultation information for presenting via a second presentation means of the user device as a function of information from the consultant system.

24. The computer program product of claim 23 wherein the consultation information includes information relating to at least one of a product or a service offering.

25. The computer program product of claim 23 wherein the consultation information includes information relating to at least one of training, education, or instruction.

26. The computer program product of claim 23 further comprising instructions for establishing the consultation session in response to a trigger event including at least one of receiving detection of a user at the user device or receiving a message indicating an input of the user at the user device.

27. The computer program product of claim 23 wherein the user device is a device from a group comprising a kiosk, a personal or laptop computer, a telephone, or a personal digital assistant.

28. The computer program product of claim 23 further comprising instructions for retrieving from a database information relating to at least one prior consultation session involving the user.

29. The computer program product of claim 28 further comprising instructions for reestablishing the prior consultation session as the consultation session.

30. The computer program product of claim 23 further comprising instructions for storing session information in a data storage system in conjunction with an identification of the user interacting with the user device.

31. The computer program product of claim 23 wherein real-time communications includes at least one of audio conferencing, videoconferencing, or instant messaging.

32. The computer program product of claim 23 wherein presenting real-time communications includes presenting audiovisual information representing a consultant in the first presentation means.

33. The computer program product of claim 32 wherein the consultant is a virtual consultant and presenting audiovisual information includes providing an anthropomorphic representation of the virtual consultant synchronized to an audio stream of speech of the virtual consultant.

34. The computer program product of claim 23 further comprising instructions for processing at the at least one consultation device audio and video information of a user at the user device.

35. The computer program product of claim 23 wherein in step A. b) includes presenting the consultation information via the second presentation means of the user device as a further function of information from the user device.

36. A consultation system for enabling consultation over a computer network, the consultation system comprising:
A. at least one consultant device, configured for communicating with a user device via a network;
B. means for establishing a consultation session between the at least one consultant device and the user device, comprising:
a) means for presenting real-time conferencing communications between the consultant device and a first presentation means of the user device; and
b) means for presenting consultation information via a second presentation means of the user device as a function of information from the consultant system.
